(19) United States
(12) Patent Application Publication
(10) Pub. No.: US 2023/0094415 A1
(43) Pub. Date: Mar. 30, 2023

(54) GENERATING A TARGET CLASSIFIER FOR A TARGET DOMAIN VIA SOURCE-FREE DOMAIN ADAPTATION USING AN ADAPTIVE ADVERSARIAL NEURAL NETWORK

(71) Applicant: Adobe Inc., San Jose, CA (US)

(72) Inventor: Handong Zhao, San Jose, CA (US)

(21) Appl. No.: 17/487,889

(22) Filed: Sep. 28, 2021

(51) Int. Cl. G06N 3/08; G06N 3/04

(52) U.S. Cl. CPC G06N 3/088; G06N 3/0454

(57) ABSTRACT

The present disclosure relates to systems, methods, and non-transitory computer readable media that generate a target classifier for a target domain via domain adaptation using a source classifier learned on a source domain. For instance, in one or more embodiments, the disclosed systems utilize an embedding model, a target classifier, and a source classifier to analyze sets of target samples and generate classification probabilities for the target samples based on the analysis. In some cases, the disclosed systems utilize the classification probabilities to modify the parameters of the target classifier via adaptive adversarial inference. In some implementations, the disclosed systems further utilize the classification probabilities to modify the parameters of the embedding model via contrastive category-wise matching. Thus, in some cases, the disclosed systems utilize the target classifier with the modified parameters to generate classifications for digital data from the target domain.

### BACKGROUND

Recent years have seen significant advancement in hardware and software platforms that expand the capabilities of machine learning models—such as neural networks—for performing certain tasks. For example, many conventional systems can adapt a neural network that learned to perform a particular task (e.g., classification) using digital data from one domain (a source domain) to perform the same task on digital data associated from another domain (a target domain). In particular, these conventional systems can leverage knowledge and training data of the source domain to improve the neural network's ability to operate within the target domain. Although conventional systems can adapt a neural network to operate within another domain, such systems often fail to flexibly adapt neural networks having low generalization capabilities or where digital data from the source domain is unavailable, leading to inaccurate performance within the target domain.

These, along with additional problems and issues exist with regard to conventional domain adaptation systems.

### SUMMARY

One or more embodiments described herein provide benefits and/or solve one or more of the foregoing or other problems in the art with systems, methods, and non-transitory computer-readable media that flexibly generate a target-specific neural network that accurately classifies digital data from a target domain via source-free domain adaptation. In particular, in one or more embodiments, the disclosed systems modify the parameters of a target classifier to enable classification within a target domain using a source classifier previously learned on a source domain. Indeed, in some cases, the source domain data used to generate the source classifier is unavailable, and the disclosed systems modify the parameters of the target classifier by exploiting the knowledge of the source domain learned by the source classifier. To illustrate, in some embodiments, the disclosed systems utilize the source and target classifiers to reduce the difference across source-similar and source-dissimilar data samples from the target domain via adaptive adversarial inference. Further, the disclosed systems utilize the source classifier to enforce the similarities between data samples from the target domain of the same class via contrastive category-wise matching. Thus, the disclosed systems flexibly leverage a source classifier learned on a source domain for accurate classification of digital data from a target domain.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a classification domain adaptation system operates in accordance with one or more embodiments;

FIG. 2A illustrates an overview diagram of the classification domain adaptation system generating a target classification neural network for a target domain in accordance with one or more embodiments;

FIG. 2B illustrates an overview diagram of a target classification neural network distinguishing between classes in a target domain in accordance with one or more embodiments;

FIG. 3 illustrates a diagram for using an adaptive adversarial neural network to generate a target classification neural network in accordance with one or more embodiments;

FIG. 4 illustrates a table reflecting experimental results regarding the effectiveness of the classification domain adaptation system in accordance with one or more embodiments;

FIG. 5 illustrates a table reflecting additional experimental results regarding the effectiveness of the classification domain adaptation system in accordance with one or more embodiments;

FIG. 6 illustrates a table reflecting further experimental results regarding the effectiveness of the classification domain adaptation system in accordance with one or more embodiments;

FIGS. 7A-7D illustrate graphical representations reflecting additional experimental results regarding the effectiveness of the classification domain adaptation system in accordance with one or more embodiments;

FIGS. 8A-8B illustrate graphical representations reflecting yet further experimental results regarding the effectiveness of the classification domain adaptation system in accordance with one or more embodiments;

FIG. 9 illustrates an example schematic diagram of a classification domain adaptation system in accordance with one or more embodiments;

FIG. 10 illustrates a flowchart of a series of acts for generating a target classification neural network for a target domain via domain adaptation of a source classification neural network learned on a source domain in accordance with one or more embodiments; and

FIG. 11 illustrates a block diagram of an exemplary computing device in accordance with one or more embodiments.

### DETAILED DESCRIPTION

One or more embodiments described herein include a classification domain adaptation system that flexibly adapts a classifier learned on a source domain to generate a target-specific classifier that accurately classifies digital data associated with a target domain. For example, in one or more embodiments, the classification domain adaptation system implements an adaptive adversarial neural network consisting of a source classifier previously learned on data samples from a source domain and a target classifier for classifying digital data associated with a target domain. The classification domain adaptation system utilizes the dual-classifier architecture to achieve adversarial domain-level alignment and contrastive category-wise matching. For instance, in some cases, the classification domain adaptation system employs the dual classifiers to adaptively distinguish between source-similar target samples (i.e., data samples from the target domain) and source-dissimilar target samples and achieve alignment across them. Further, the classification domain adaptation system exploits the source knowledge of the source classifier in a self-supervised manner to learn robust and discriminative features and enforce the positive relation between paired target features to achieve category-wise alignment.

To provide an illustration, in one or more embodiments, the classification domain adaptation system generates a target classification neural network for a target domain via domain adaptation of a source classification neural network learned on a source domain. In particular, the classification domain adaptation system extracts target feature vectors from a set of target samples from the target domain. Additionally, the classification domain adaptation system generates, utilizing the target classification neural network, target classification probabilities for the set of target samples from the target feature vectors. The classification domain adaptation system further generates, utilizing the source classification neural network, source classification probabilities for the set of target samples from the target feature vectors. Using the target classification probabilities and the source classification probabilities, the classification domain adaptation system modifies parameters of the target classification neural network.

As mentioned, in one or more embodiments, the classification domain adaptation system implements an adaptive adversarial neural network for generating a target classification neural network. For example, in some cases, the classification domain adaptation system utilizes the adaptive adversarial neural network to learn parameters for the target classification neural network that facilitate effective classification of digital data from a target domain. In some embodiments, the adaptive adversarial neural network includes a dual-classifier architecture having the target classification neural network and a source classification neural network. In some cases, the adaptive adversarial neural network further includes an embedding model.

In some implementations, the source classification neural network includes a classification neural network learned on a source domain. In particular, the source classification neural network includes learned parameters that facilitate effective classification of digital data from a source domain. In some cases, the source samples used to learn the parameters of the source classification neural network are unavailable for use in the adaptive adversarial neural network. Accordingly, the classification domain adaption system incorporates the source classification neural network to leverage the knowledge it learned of the source domain. In some cases, the embedding model includes an embedding model also learned on the source domain.

In one or more embodiments, the classification domain adaptation system utilizes the adaptive adversarial neural network to generate the target classification neural network via adaptive adversarial inference. For example, in some implementations, the classification domain adaptation system utilizes the embedding model to extract target feature vectors from a set of target samples. The classification domain adaptation system further utilizes the source classification neural network and the target classification neural network to generate classification probabilities for the set of target samples using the target feature vectors. To illustrate, in some cases, the classification domain adaptation system utilizes the source classification neural network to generate one or more source classification probabilities (e.g., a distribution of probabilities across various classes) for each target sample and utilizes the target classification neural network to generate one or more target classification probabilities (e.g., a distribution of probabilities across various classes) for each target sample.

In some embodiments, the classification domain adaptation system modifies parameters of the target classification neural network using the source classification probabilities and the target classification probabilities corresponding to the set of target samples. For instance, in some cases, the classification domain adaptation system utilizes the source classification probabilities and the target classification probabilities to determine a source-similar weight and a source-dissimilar weight for each target sample. In some cases, the classification domain adaptation system further determines one or more adversarial losses using the source-similar weights and source-dissimilar weights of the target samples. Accordingly, the classification domain adaptation system modifies the parameters of the target classification neural network using the one or more determined adversarial losses.

In some embodiments, the classification domain adaptation system further utilizes the adaptive adversarial neural network to generate the target classification neural network via contrastive category-wise matching. For instance, in some implementations, the classification domain adaptation system utilizes the source classification probabilities generated by the source classification neural network to determine positive sample pairs (e.g., target samples corresponding to the same classification).

In some cases, the classification domain adaptation system modifies parameters of the embedding model using the determined positive sample cases. To illustrate, in some instances, the classification domain adaptation system determines similarity metrics for the positive sample pairs. Further, the classification domain adaptation system determines a contrastive loss using the similarity metrics and modifies the parameters of the embedding model using the contrastive loss. In some cases, the classification domain adaptation system further uses one or more adversarial losses determined from the source-similar weights and source-dissimilar weight of the target samples to modify the parameters of the embedding model.

In one or embodiments, the classification domain adaptation system modifies the parameters of the embedding model and the parameters of the target classification neural network via an iterative process. In some implementations, the classification domain adaptation system alternates between modifying parameters of the embedding model and parameters of the target classification neural network. In particular, the classification domain adaptation system modifies the parameters of the embedding model via one set of parameter update iterations and modifies the parameters of the target classification neural network via another set of parameter update iterations. In some cases, the classification domain adaptation system alternates between sets of parameter update iterations periodically (e.g., every other iteration).

In some cases, the classification domain adaptation system utilizes the target classification neural network to classify digital data from the target domain. In particular, the classification domain adaptation system employs the target classification neural network to generate classifications for digital data from the target domain. In some cases, the classification domain adaptation system also utilizes the embedding model to extract, from the digital data, feature vectors used by the target classification neural network for generating the classifications.

As mentioned above, conventional domain adaptation systems suffer from several technological shortcomings that result in inflexible and inaccurate operation. For instance, many conventional systems are inflexible in that they rigidly rely on digital data from the source domain to adapt a neural network classifier learned on that data. For instance, some conventional systems adapt the neural network classifier by transforming source data and target data into high level features to achieve alignment of their feature distributions. Other conventional systems may use the digital data from the source domain to exploit a feature generator to deceive a domain discriminator so that it fails to recognize whether features correspond to the source domain or the target domain. Such systems, however, fail to flexibly adapt neural network classifiers to a target domain where the corresponding source domain data is unavailable (e.g., due to privacy concerns or the memory limitations of the implementing device).

Some conventional domain adaptation systems overcome the unavailability of source domain data by freezing the neural network classifier learned on the source domain and directly adjusting target features to align them with the source domain. For instance, some conventional systems fine tune the feature extractor to shorten the distance between features from the target domain and the boundary of the source domain. Some systems utilize the frozen neural network classifier to guide the generation of target samples that are close to the source domain for use in the domain adaptation. Such systems, however, still rely on the source domain data underlying the neural network classifier. Where the source domain data is insufficient or unbalanced, or the discrepancy between the source domain and the target domain is significant, the generalization of the neural network classifier is poor. As a result, these systems typically fail to flexibly move the target features into the source domain boundary sufficiently to allow the neural network classifier to properly adapt to the target domain—particularly where the target features are abundant and largely variant. Because the neural network classifier learned on the source domain is frozen, these conventional systems rely heavily on the ability to move the target features for adaptation to the target domain.

In addition to flexibility concerns, conventional domain adaptation systems often fail to adapt neural network classifiers for accurate performance in the target domain. Indeed, because conventional systems fail to perform domain adaptation flexibly in the absence of the source domain data or where such source domain data is unbalanced, insufficient, or significantly different than the target domain, the conventional systems fail to produce accurate neural network classifiers. Indeed, such systems fail to produce neural network classifiers that can accurately correlate target domain features with categories, leading to inaccurate classifications—especially where those target domain features are significantly different from the source domain features.

The classification domain adaptation system can provide several advantages over conventional systems. For example, the classification domain adaptation system can operate more flexibly than conventional systems. Indeed, by utilizing an adaptive adversarial neural network with a dual-classifier design to generate a target classification neural network, the classification domain adaptation system can flexibly adapt the knowledge of the included source classification neural network learned on a source domain to target features within the target domain. Thus, the classification domain adaptation system can perform flexible domain adaptation (without use of the source domain data in many instances). Further, by modifying parameters of the target classification neural network and embedding model using determined source classification probabilities, target classification probabilities, and positive sample pairs, the classification domain adaptation system can more flexibly reduce the distinctions between various target features of the target domain. Accordingly, in some cases, the classification domain adaptation system more flexibly generalizes across the target features.

Additionally, the classification domain adaptation system can operate more accurately than conventional systems. Indeed, by generating a target classification neural network via an adaptive adversarial neural network, the classification domain adaptation system can more accurately adapt to the target domain. In particular, the classification domain adaptation system can generate more accurate classifications for digital data from the target domain when compared to conventional systems.

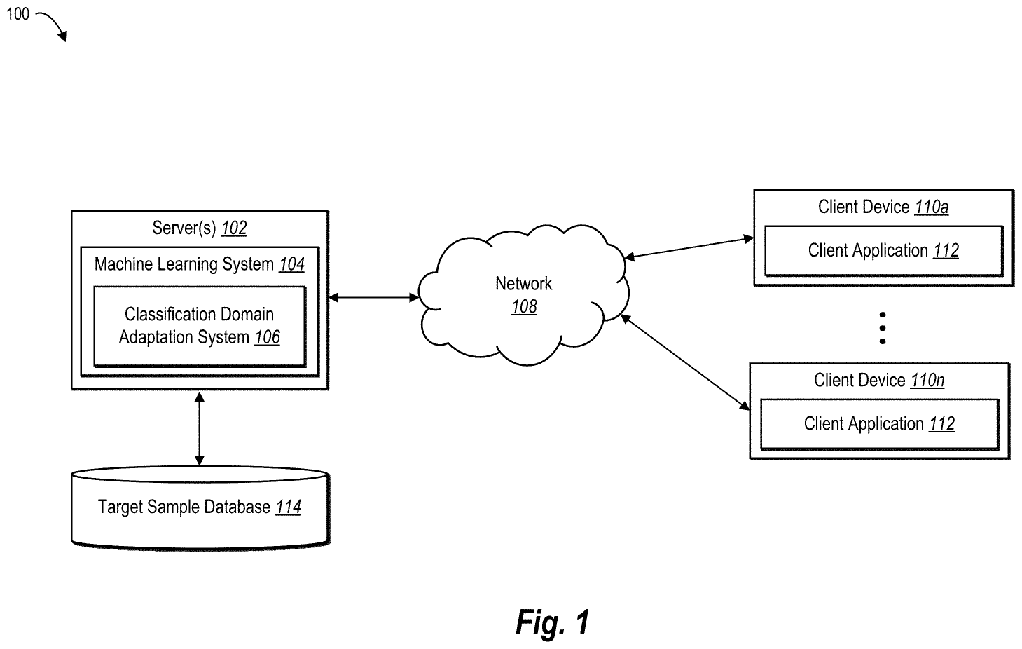

Additional detail regarding the classification domain adaptation system will now be provided with regard to the figures. For example, FIG. 1 illustrates a schematic diagram of an exemplary system environment (“environment”) 100 in which a classification domain adaptation system 106 can be implemented. As illustrated in FIG. 1, the environment 100 includes a server(s) 102, a network 108, client devices 110a-110n, and a target sample database 114.

Although the environment 100 of FIG. 1 is depicted as having a particular number of components, the environment 100 can have any number of additional or alternative components (e.g., a different number of servers, client devices, target sample databases, or other components in communication with the classification domain adaptation system 106 via the network 108). Similarly, although FIG. 1 illustrates a particular arrangement of the server(s) 102, the network 108, the client devices 110a-110n, and the target sample database 114, various additional arrangements are possible.

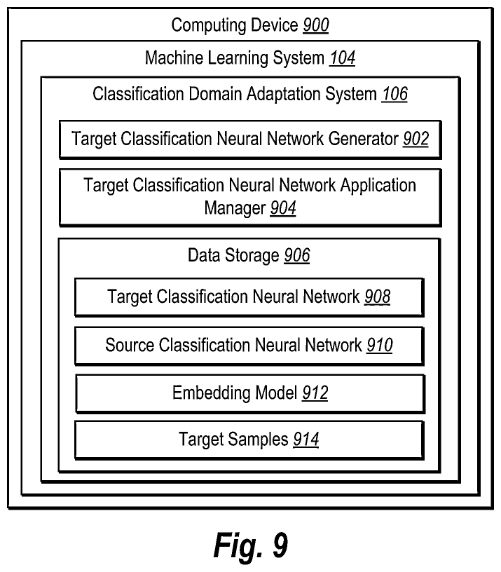

The server(s) 102, the network, 108, the client devices 110a-110n, and the target sample database 114 may be communicatively coupled with each other either directly or indirectly (e.g., through the network 108 as discussed in greater detail below in relation to FIG. 9). Moreover, the server(s) 102 and the client devices 110a-110n may include a variety of computing devices (including one or more computing devices as discussed in greater detail with relation to FIG. 9).

As mentioned above, the environment 100 includes the server(s) 102. In one or more embodiments, the server(s) 102 generates, stores, receives, and/or transmits digital data, including digital data corresponding to a target domain. To provide an illustration, in some instances, the server(s) 102 receives, from a client device (e.g., one of the client devices 110a-110n), digital data having target features (e.g., data features associated with the target domain) and provides a classification of the digital data in return. In one or more embodiments, the server(s) 102 comprises a data server. In some embodiments, the server(s) 102 comprises a communication server or a web-hosting server.

As shown in FIG. 1, the server(s) 102 includes a machine learning system 104. In particular, in one or more embodiments, the machine learning system 104 initializes, generates (e.g., trains), and/or implements machine learning models, such as classification neural networks. For example, in some instances, the machine learning system 104 accesses a target sample database and generates a target classification neural network utilizing the target sample database. In some cases, the machine learning system 104 further utilizes the target neural network classifier to generate classifications for digital data associated with a target domain.

Additionally, the server(s) 102 includes the classification domain adaptation system 106. In particular, in one or more embodiments, the classification domain adaptation system 106 generates a target classification neural network for classifying digital data from a target domain. For example, in some instances, the classification domain adaptation system 106 utilizes the server(s) 102 to implement an adaptive adversarial neural network with a dual-classifier architecture to generate a target classification neural network.

To illustrate, in one or more embodiments, the classification domain adaptation system 106, via the server(s) 102, generates a target classification neural network for a target domain via domain adaptation of a source classification neural network learned on a source domain. In particular, via the server(s) 102, the classification domain adaptation system 106 extracts target feature vectors from a set of target samples from the target domain. Via the server(s) 102, the classification domain adaptation system 106 further generates target classification probabilities for the set of target samples from the target feature vectors utilizing the target classification neural network. Additionally, via the server(s) 102, the classification domain adaptation system 106 generates source classification probabilities for the set of target samples from the target feature vectors utilizing the source classification neural network. Utilizing the target classification probabilities and the source classification probabilities, the classification domain adaptation system 106, via the server(s) 102, modifies parameters of the target classification neural network.

In one or more embodiments, the target sample database 114 stores target samples. For example, in some instances, the target sample database 114 stores target samples collected by the server(s) 102 (e.g., the classification domain adaptation system 106 via the server(s) 102). The target sample database 114 further provides access to the target samples to the classification domain adaptation system 106. Though FIG. 1, illustrates the target sample database 114 as a distinct component, one or more embodiments include the target sample database 114 as a component of the server(s) 102, the machine learning system 104, or the classification domain adaptation system 106.

In one or more embodiments, the client devices 110a-110n include computing devices that are capable of transmitting and/or receiving digital data associated with a target domain. For example, in some implementations, the client devices 110a-110n include at least one of a smartphone, a tablet, a desktop computer, a laptop computer, a head-mounted-display device, or other electronic device. In some instances, the client devices 110a-110n include one or more applications (e.g., the client application 112) that are capable of transmitting and/or receiving digital data associated with a target domain. For example, in some embodiments, the client application 112 includes a software application installed on the client devices 110a-110n. In other cases, however, the client application 112 includes a web browser or other application that accesses a software application hosted on the server(s) 102. In some implementations, the client devices 110a-110n can train a target classification neural network and/or apply a target classification neural network (e.g., to classify a new data sample, such as a digital image, available at the client device).

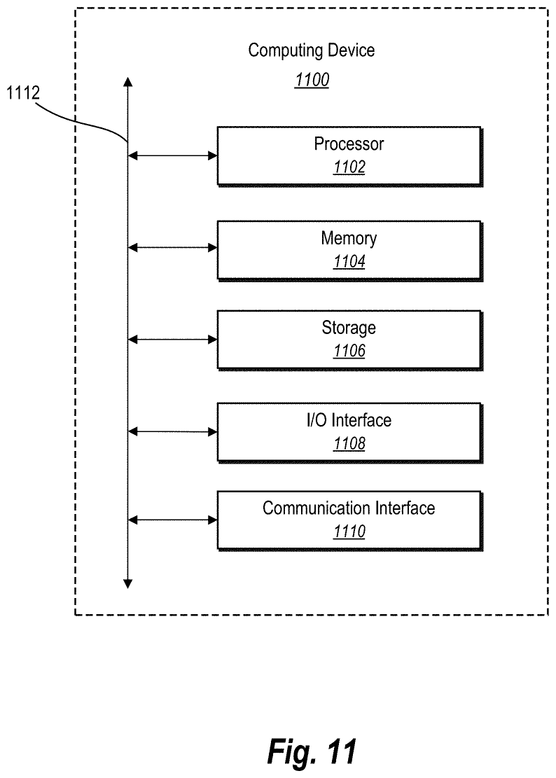

The classification domain adaptation system 106 can be implemented in whole, or in part, by the individual elements of the environment 100. Indeed, although FIG. 1 illustrates the classification domain adaptation system 106 implemented with regard to the server(s) 102, different components of the classification domain adaptation system 106 can be implemented by a variety of devices within the environment 100. For example, one or more (or all) components of the classification domain adaptation system 106 can be implemented by a different computing device (e.g., one of the client devices 110a-110n) or a separate server from the server(s) 102 hosting the machine learning system 104. Example components of the classification domain adaptation system 106 will be described below with regard to FIG. 11.

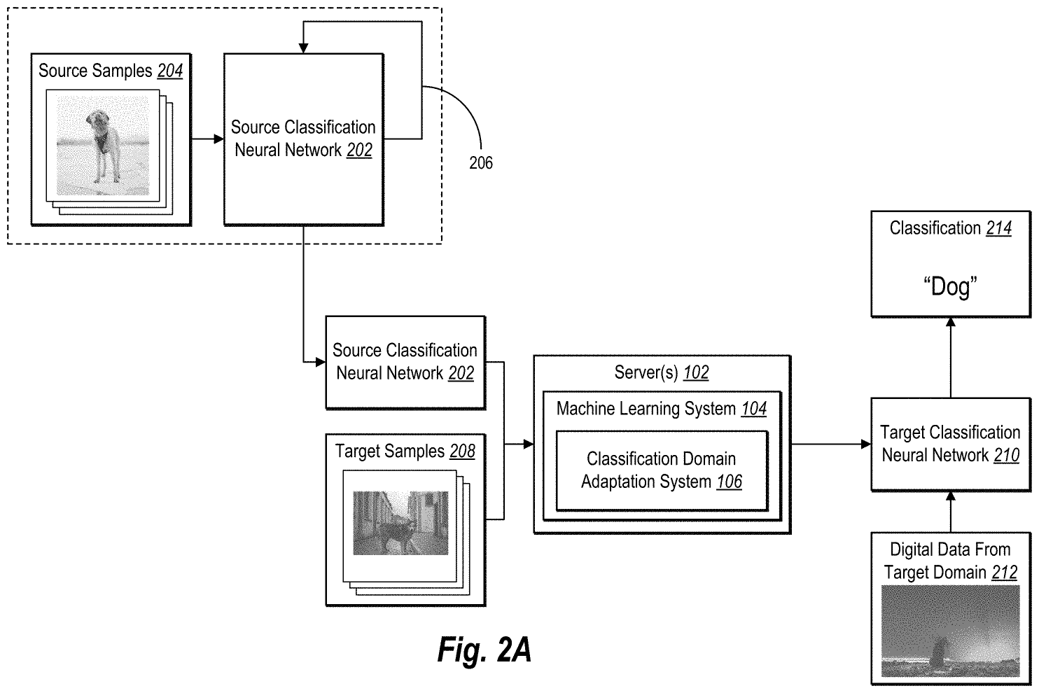

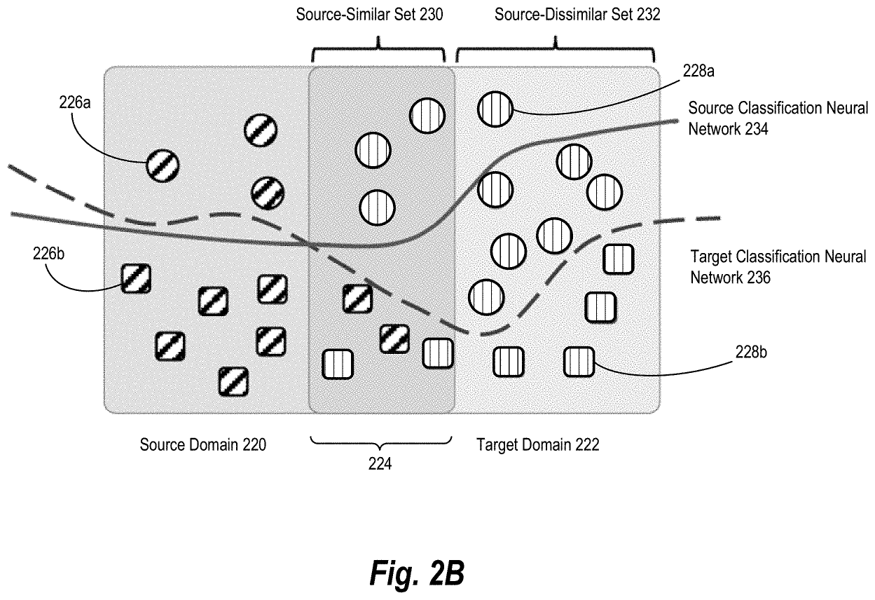

As mentioned above, the classification domain adaptation system 106 generates a target classification neural network for classifying digital data associated with a target domain. FIGS. 2A-2B illustrate overview diagrams of the classification domain adaptation system 106 generating a target classification neural network in accordance with one or more embodiments.

As shown by FIGS. 2A-2B, the classification domain adaptation system 106 generates a target classification neural network via domain adaptation. In one or more embodiments, domain adaptation includes a process for adapting knowledge (e.g., information) of a computer-implemented algorithm or model associated with one domain for use in another domain. In some embodiments, domain adaptation includes a process for adapting the knowledge of a machine learning model—such as a neural network—learned from a source domain (e.g., learned via training using data samples from the source domain) for use within another domain. To illustrate, in some cases, domain adaptation includes a process for adapting a classification model generated to classify digital data from a source domain for use in classifying digital data from a target domain.

In one or more embodiments, a domain includes a collection of digital data. In particular, in some cases, a domain includes a set of related digital data. To illustrate, in some implementations, a domain includes a set of digital data having one or more common characteristics or attributes (e.g., a set of digital images captured in the daylight or a set of digital images captured at nighttime or another low light environment). Accordingly, in one or more embodiments, a source domain includes a set of digital data for which a computer-implemented model has previously been generated (e.g., a set of digital data for which a machine learning model was trained to process). Further, in some cases a target domain includes a set of digital data for which a computer-implemented model is generated or modified (e.g., a set of digital data for which the training of a machine learning model targets).

It should be understood that, while much of the following discusses domain adaptation in the context of digital images and digital image classification, the embodiments of the classification domain adaptation system 106 similarly apply to other domain adaptation contexts. For instance, one or more embodiments of the classification domain adaptation system 106 operate within the context of analyzing user data. To illustrate, in some implementations, the classification domain adaptation system 106 generates a target classification neural network to analyze digital data associated with one entity (e.g., the target domain) using knowledge obtained from digital data associated with another entity (e.g., the source domain). Thus, the classification domain adaptation system 106 applicable to many various contexts in which information from one domain is utilized to modify or generate a machine learning model, such as a neural network, for use in another domain.

In particular, as illustrated by FIG. 2A, the classification domain adaptation system 106 identifies, generates, obtains, or otherwise accesses a source classification neural network 202 for use in generating a target classification neural network 210 via domain adaptation. Generally, in one or more embodiments, a neural network includes a type of machine learning model, which can be tuned (e.g., trained) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on a plurality of inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial neural network, a graph neural network, or a multi-layer perceptron. In some embodiments, a neural network includes a combination of neural networks or neural network components.

More particularly, in some embodiments, a source classification neural network includes a computer-implemented neural network that generates classifications for digital data from a source domain. Indeed, in some embodiments, a source classification neural network includes a neural network that analyzes digital data from a source domain and generates a classification for the digital data. For instance, in some cases, a source classification neural network analyzes the data features of digital data from the source domain and generates the classification based on the data features. In some cases, a source classification neural network generates a classification by generating a probability distribution across various potential classes.

Similarly, in one or more embodiments, a target classification neural network includes a computer-implemented neural network that generates classifications for digital data from a target domain. Indeed, in some embodiments, a target classification neural network includes a neural network that analyzes digital data from a target domain and generates a classification for the digital data. For instance, in some cases, a target classification neural network analyzes data features of digital data from the target domain and generates the classification based on the data features. In some cases, a target classification neural network generates a classification by generating a probability distribution across various potential classes.

In one or more embodiments, the classification domain adaptation system 106 accesses the source classification neural network 202 by receiving the source classification neural network 202 from a third-party system. For instance, in some cases, the classification domain adaptation system 106 receives the source classification neural network 202 from a third-party system that has generated (e.g., trained) the source classification neural network 202. In some cases, the classification domain adaptation system 106 generates (e.g., trains) the source classification neural network 202 itself. For instance, in some embodiments, the classification domain adaptation system 106 generates the source classification neural network 202, store the source classification neural network 202, and then access the source classification neural network 202 for domain adaptation.

To provide an illustration, as shown in FIG. 2A, the classification domain adaptation system 106 generates the source classification neural network 202 utilizing source samples 204. In one or more embodiments, a source sample includes a data sample (e.g., a sample of digital data) from a source domain. For instance, as illustrated in FIG. 2A, the source samples 204 include digital images portraying images of an animal captured in the daylight.

In one or more embodiments, the classification domain adaptation system 106 generates the source classification neural network 202 by learning parameters for the source classification neural network 202 that facilitate the classification of digital data from the source domain. For instance, in some embodiments, the classification domain adaptation system 106 utilizes the source classification neural network 202 to generate predicted classifications for the source samples 204, determines a loss from the predictions (e.g., via comparisons with ground truths), and modifies the parameters of the source classification neural network 202 based on the determined loss (as shown by the line 206).

As shown in FIG. 2A, in some implementations the classification domain adaptation system 106 utilizes the source classification neural network 202—but not the source samples 204 underlying the source classification neural network 202—to generate the target classification neural network 210. Indeed, in one or more embodiments, the source samples 204 is not available for use in performing the domain adaptation. For example, in some cases, the source samples 204 are not used in accordance with privacy concerns, such as where the source samples 204 are associated with a particular entity (e.g., a user or business) and may contain sensitive data. In other cases, the data required by the source samples 204 exceeds the limitations of the computing device implementing the classification domain adaptation system 106. Thus, in some embodiments, the classification domain adaptation system 106 leverages the knowledge of the source domain learned by the source classification neural network 202 via its generation process.

In some implementations, the classification domain adaptation system 106 freezes the source classification neural network 202. In other words, the classification domain adaptation system 106 prevents further modification of the source classification neural network 202 during the domain adaptation process.

Further, as shown in FIG. 2A, the classification domain adaptation system 106 identifies, retrieves, or otherwise accesses target samples 208. In one or more embodiments, a target sample includes a data sample from the target domain. For instance, as illustrated in FIG. 2A, the target samples 208 include digital images portraying images of an animal captured at nighttime or in some other low light environment.

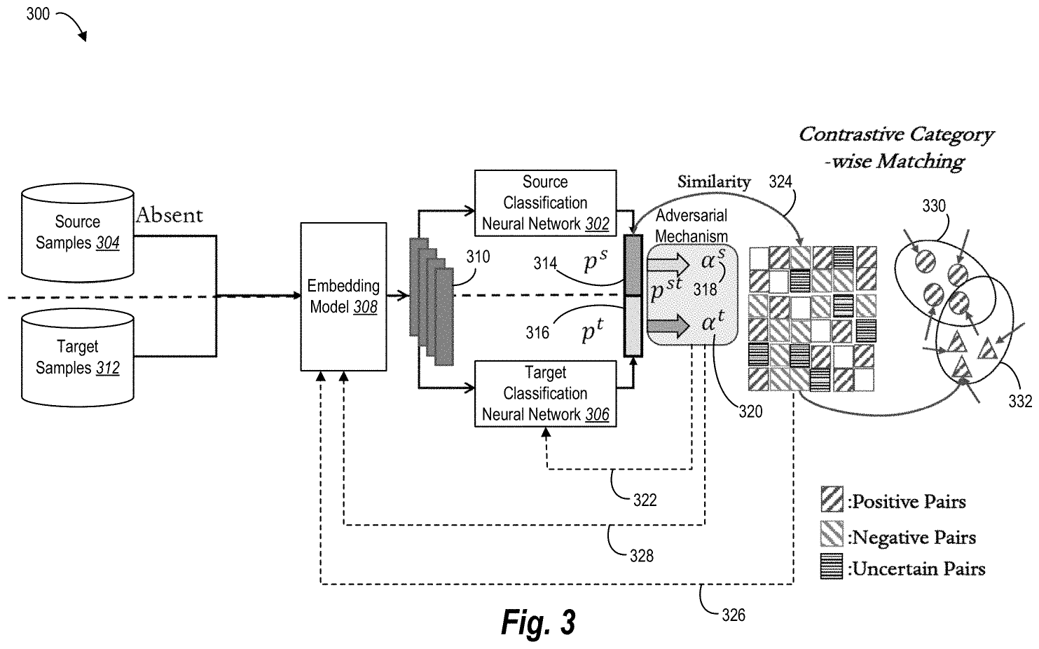

As illustrated, using the source classification neural network 202 and the target samples 208, the classification domain adaptation system 106 generates the target classification neural network 210. For example, in one or more embodiments, the classification domain adaptation system 106 generates (e.g., modifies) parameters of the target classification neural network 210 using the source classification neural network 202 and the target samples 208. To illustrate, in some implementations, the classification domain adaptation system 106 incorporates the source classification neural network 202 and the target classification neural network 210 into a dual-classifier architecture of an adaptive adversarial neural network and generates parameters for the target classification neural network 210 based on analyses of the target samples 208 via the adaptive adversarial neural network. Use of the adaptive adversarial neural network will be discussed in more detail below with reference to FIG. 3.

As shown in FIG. 2A, the classification domain adaptation system 106 utilizes the target classification neural network 210 generated using the source classification neural network 202 and the target samples 208 to generate a classification 214 for digital data 212 from the target domain. In particular, as shown in FIG. 2A, the digital data 212 includes a digital image portraying an image of an animal captured at nighttime or some other low light environment.

In one or more embodiments, the classification domain adaptation system 106 generates the classification 214 by generating an indication of a class associated with the 212. In some cases, the classification domain adaptation system 106 generates the classification 214 by generating a distribution of probabilities across a plurality of classes (e.g., with the highest probability indicating the most likely class for the digital data 212). In other embodiments, the classification domain adaptation system 106 generates the classification 214 by generating a binary indication of whether the digital data 212 is associated with a particular class.

In one or more embodiments, a class includes a category. In particular, in some embodiments, a class includes a categorization of digital data based on one or more data features of the digital data. For instance, in some cases, a class corresponds to a particular set of data features or a set of data features having particular values or values within a particular range.

FIG. 2B illustrates an additional overview diagram of the classification domain adaptation system 106 generating a target classification neural network for a target domain. In particular, FIG. 2B illustrates how the classification domain adaptation system 106 generates a target classification neural network to accurately distinguish between different classes of digital data from a target domain.

As shown in FIG. 2B, a source domain 220 includes a plurality of source samples corresponding to multiple classes, such as the source sample 226a corresponding to a circle class and the source sample 226b corresponding to a square class. Similarly, a target domain 222 includes a plurality of target samples corresponding to the same classes, such as a target sample 228a corresponding to the circle class and a target sample 228b corresponding to the square class. As shown, the source samples and the target samples are positioned differently within their respective domain, indicating the differences between their corresponding data features.

As illustrated in FIG. 2B, a region of overlap 224 exists for the source domain 220 and the target domain 222, indicating that the domains share commonalities in one or more of their data features. Further, the source domain 220 includes some source samples within the region of overlap 224 and some source samples outside of the region of overlap 224. Similarly, the target domain 222 includes some target samples within the region of overlap 224 and some target samples outside the region of overlap 224.

Thus, as shown, the target domain 222 includes a set of source-similar target samples 230 and a set of source-dissimilar target samples 232. In one or more embodiments, a source-similar target sample includes a target sample that is similar to digital data from a source domain. For example, in some embodiments, a source-similar target sample includes a target sample having one or more data features that are measurably similar to one or more data features of digital data from the source domain. In some instances, a source-similar target sample includes a target sample that includes one or more data features that are also associated with digital data from the source domain. In other words, a source-similar target sample includes one or more data features that are also included in digital data from the source domain.

Conversely, in one or more embodiments, a source-dissimilar target sample includes a target sample that is dissimilar to (e.g., different from) digital data from a source domain. For instance, in some embodiments, a source-dissimilar target sample includes a target sample having data features that are not similar to data features associated with digital data from the source domain. In some cases, a source-dissimilar target sample includes a target sample having data features that are not also associated with digital data from the source domain.

In one or more embodiments, the determination of whether a target sample is source-similar or source-dissimilar varies across embodiment. For instance, in some cases, a source-similar target sample includes a target sample having at least a threshold number of data features that are also associated with the source domain while a source-dissimilar target sample includes a target sample has less than a threshold number of such data features. Likewise, in some instances, a source-similar target sample includes a data sample having one or more data features that have a measure of similarity with data features of digital data from the source domain that satisfy a similarity threshold while a source-dissimilar data sample does not. In other words, in some cases, the classification domain adaptation system 106 determines that a target sample is a source-similar target sample even if it is positioned outside the region of overlap 224 or is a source-dissimilar target sample even if it is positioned within the region of overlap 224.

As shown in FIG. 2B, a source classification neural network 234 learned (e.g., trained or otherwise generated) on the source samples from the source domain 220 accurately distinguishes between source samples associated with the circle class and source samples associated with the square class (as shown by the trajectory separating the classes). As further shown, however, the source classification neural network 234 has difficulty distinguishing between target samples associated with the circle class and target samples associated with the square class. In particular, the source classification neural network 234 has difficulty making accurate distinctions among source-dissimilar target samples—as shown in FIG. 2B where the source classification neural network 234 divides several source-dissimilar target samples that are associated with the circle class into the square class. Accordingly, FIG. 2B illustrates that the source classification neural network 234 can have similar difficulty making accurate distinctions among other digital data from the target domain 222.

In some embodiments, the difficulty of the source classification neural network 234 in making accurate distinctions in the target domain is due to an imbalance of the source samples used to generate the source classification neural network 234. For instance, FIG. 2B shows half as many source samples associated with the circle class compared to those associated with the target class. Further, in some cases, the classification domain adaptation system 106 freezes the source classification neural network 234, preventing further modification of the source classification neural network 234.

As further shown in FIG. 2B, a target classification neural network 236 learned on the target samples from the target domain 222 accurately distinguishes between target samples associated with the circle class and target samples associated with the square class. Accordingly, FIG. 2B illustrates that the target classification neural network 236 can similarly make accurate distinctions among other digital data from the target domain 222. Thus, in one or more embodiments, the classification domain adaptation system 106 generates the target classification neural network 236 to improve the accuracy of generating distinctions among digital data from the target domain 222.

Indeed, as shown by FIG. 2B, by generating a target classification neural network for a target domain, the classification domain adaptation system 106 improves upon flexibility and accuracy when compared to conventional systems. Indeed, by generating a target classification neural network, the classification domain adaptation system 106 more flexibly adapts to a target domain when compared to many conventional systems that utilize a neural network classifier learned on a source domain and attempt to adjust target features so that they fit within the generalization capabilities of the neural network classifier. Because the classification domain adaptation system 106 more flexibly adapts to the target domain, the classification domain adaptation system 106 also provides more accurate classification for both source-similar and source-dissimilar digital data from the target domain. Indeed, the classification domain adaptation system 106 distinguishes between classes of digital data within the target domain more accurately and generates more accurate classifications for the digital data as a result.

As discussed above, in one or more embodiments, the classification domain adaptation system 106 generates a target classification neural network for a target domain using an adaptive adversarial neural network that includes a dual-classifier architecture. FIG. 3 illustrates a diagram for using an adaptive adversarial neural network to generate a target classification neural network in accordance with one or more embodiments.

Indeed, FIG. 3 shows an adaptive adversarial neural network 300. In one or more embodiments, an adaptive adversarial neural network includes a computer-implemented neural network for domain adaptation. In particular, in some embodiments, an adaptive adversarial neural network includes a neural network having a dual-classifier structure that learns/generates parameters for a target classification neural network to operate within a target domain using a source classification neural network learned on a source domain. For example, in some implementations, an adaptive adversarial neural network learns/generates parameters for the target classification neural network via adaptive adversarial inference and/or contrastive category-wise matching.

As shown in FIG. 3, the adaptive adversarial neural network 300 includes the source classification neural network 302 learned on the source samples 304. Additionally, the adaptive adversarial neural network 300 includes the target classification neural network 306. Further, as shown, the adaptive adversarial neural network 300 includes the embedding model 308. As indicated by FIG. 3, the source samples 304 are absent. In other words, the source samples 304 are unavailable for use by the adaptive adversarial neural network 300.

In one or more embodiments, an embedding model includes a computer-implemented algorithm or model for extracting data features from digital data. In particular, in some embodiments, an embedding model includes a computer-implemented model that analyzes an instance of digital data and identifies one or more patent and/or latent data features for the instance of digital data. To illustrate, in one or more embodiments, an embedding model includes a computer-implemented model that generates one or more values (e.g., feature vectors) representing one or more data features of an instance of digital data.

In one or more embodiments, the embedding model 308 includes an embedding model learned on a source domain, such as the source domain upon which the source classification neural network 302 was learned. For example, in some implementations, the embedding model 308 includes an embedding model that was learned using the source samples 304 (e.g., either separately or in conjunction with the source classification neural network 302). Thus, in some embodiments, the classification domain adaptation system 106 also incorporates knowledge of the source domain contained by the embedding model 308.

As shown in FIG. 3, the classification domain adaptation system 106 utilizes the adaptive adversarial neural network 300 to perform the domain adaption using the target samples 312. In some embodiments, the classification domain adaptation system 106 utilizes the adaptive adversarial neural network 300 to analyze the target samples 312 in sets (e.g., batches). Accordingly, as will be discussed below, the classification domain adaptation system 106 generates the target classification neural network 306 via an iterative process where the adaptive adversarial neural network 300 analyzes a set of target samples for each iteration. In some implementations, however, the classification domain adaptation system 106 utilizes the adaptive adversarial neural network 300 to analyze one target sample per iteration.

As shown in FIG. 3, the classification domain adaptation system 106 utilizes the embedding model 308 of the adaptive adversarial neural network 300 to extract target feature vectors 310 from the target samples 312. In one or more embodiments, a target feature vector includes a vector representing one or more data features of a target sample. In particular, in some embodiments, a target feature vector includes a vector that includes one or more values representing one or more data features of a target sample. To illustrate, in some implementations, a target feature vector includes a vector of one or more values generated by an embedding model, where the one or more values represent patent and/or latent data features of a target sample.

In one or more embodiments, the classification domain adaptation system 106 utilizes the embedding model 308 to extract one target feature vector per target sample from the set of target samples. In some cases, however, the classification domain adaptation system 106 utilizes the embedding model 308 to extract multiple target feature vectors per target sample.

As illustrated in FIG. 3, the classification domain adaptation system 106 utilizes the source classification neural network 302 of the adaptive adversarial neural network 300 to generate source classification probabilities 314 from the target feature vectors 310. Further, as shown, the classification domain adaptation system 106 utilizes the target classification neural network 306 of the adaptive adversarial neural network 300 to generate target classification probabilities 316 from the target feature vectors 310. For example, in some implementations, the classification domain adaptation system 106 generates a source classification probability and a target classification probability for each target sample (e.g., based on its corresponding target feature vector) in the set of target samples.

In one or more embodiments, a classification probability includes a probability that an instance of digital data is associated with a particular class. In particular, in some embodiments, a classification probability includes a value that indicates, based on data features associated with an instance of digital data, a likelihood that the instance of data is associated with a particular class. To illustrate, in one or more embodiments, a classification probability includes a value generated by a classification neural network that indicates the likelihood that a target sample from a target domain is associated with a particular category. Thus, in one or more embodiments, a source classification probability includes a classification probability generated by a source classification neural network. Similarly, in one or more embodiments, a target classification probability includes a classification probability generated by a target classification neural network.

In some implementations, the classification domain adaptation system 106 generates a source classification probability and a target classification probability for a target sample by generating a distribution of probabilities across a plurality of classes. Indeed, in some embodiments, a source classification probability and a target classification probability include a distribution of probabilities with each probability providing a value that indicates a likelihood that the target sample is associated with a class corresponding to that particular probability. In one or more embodiments, the classification domain adaptation system 106 generates a source classification probability and a target classification probability for a target sample as follows:

pᵢ^{s}=Cₛ(F(xᵢ^{t}))∈ [symbol] ^{K} (1)

pᵢ^{t}=Cₜ(F(xᵢ^{t}))∈ [symbol] ^{K} (2)

In equations 1-2, pᵢ^{s} represents the source classification probability, and pᵢ^{t} represents the target classification probability generated for target sample xᵢ^{t}. Additionally, Cₛ(⋅) represents the source classification neural network 302 and Cₜ(⋅) represents the target classification neural network 306. Further, F(⋅) represents the embedding model 308 so that F(xᵢ^{t}) corresponds to the target feature vector extracted from target sample xᵢ^{t}. Finally, K represents the number of classes so that pᵢ^{s} and pᵢ^{t} each correspond to a distribution of probabilities over multiple classes when K>1.

As further shown in FIG. 3, the classification domain adaptation system 106 generates a source-similar weight 318 and a source-dissimilar weight 320 for a target sample using its corresponding source classification probability and its corresponding target classification probability. In particular, in some embodiments, the classification domain adaptation system 106 generates a source-similar weight and a source-dissimilar weight for each target sample in the set. In one or more embodiments, the classification domain adaptation system 106 generates the source-similar weight 318 and the source-dissimilar weight 320 as follows:

p₍ᵢ₎^{st}=σ([pᵢ^{s}pᵢ^{t}]^{T}) (3)

αᵢ^{s}=Σₖ₌₁^{K}p₍ᵢ₎ₖ^{st} (4)

αᵢ^{t}=Σ_{k=K+1}^{2K}p₍ᵢ₎ₖ^{st} (5)

In equations 3, σ(⋅) represents a Softmax function. Thus, p₍ᵢ₎^{st} represents a distribution of probabilities generated by combining (e.g., concatenating) the source classification probability and the target classification probability for target sample xᵢ^{t} and then activating the combined distribution of probabilities via the Softmax function σ(⋅). Accordingly, p₍ᵢ₎^{st} represents a normalized distribution of probabilities for the target sample xᵢ^{t}. In equation 4, αᵢ^{s} represents the source-similar weight generated for the target sample xᵢ^{t}. Similarly, in equation 5, αᵢ^{t}, represents the source-dissimilar weight generated for the target sample xᵢ^{t}.

In one or more embodiments, a source-similar weight includes a value indicative of a target sample being a source-similar target sample. In particular, in one or more embodiments, a source-similar weight includes a value, such as a probability indicating a likelihood that a target sample is a source-similar target sample. Conversely, in one or more embodiments, a source-dissimilar weight includes a value indicative of a target sample being a source-similar target sample. In particular, in one or more embodiments, a source-dissimilar weight includes a value, such as a probability indicating a likelihood that a target sample is a source-dissimilar target sample. Indeed, in one or more embodiments, the classification domain adaptation system 106 utilizes the source-similar weight and the source-dissimilar weight for a target sample as a voting score indicative of whether the target sample is a source-similar target sample or a source-dissimilar target sample.

As shown in FIG. 3, the classification domain adaptation system 106 utilizes the source-similar weights and the source-dissimilar weights for the set of target samples to modify the target classification neural network 306 (e.g., via back propagation as shown by the dashed line 322). In particular, in one or more embodiments, the classification domain adaptation system 106 modifies the parameters of the target classification neural network 306. In one or more embodiments, a parameter includes a variable that is internal to a computer-implemented model, such as a source classification neural network, a target classification neural network, or an embedding model. In particular, in some embodiments, a parameter includes a variable that affects the operation of the corresponding computer-implemented model. For instance, in some cases, a parameter includes a weight of a layer of a computer-implemented model that affects the outcome generated by the model.

As indicated by FIG. 3, the classification domain adaptation system 106 utilizes the source-similar weights and source-dissimilar weights to modify the parameters of the target classification neural network 306 via adaptive adversarial inference. In particular, in one or more embodiments, the classification domain adaptation system 106 modifies the parameters of the target classification neural network 306 using one or more adversarial losses determined using the source-similar weights and the source-dissimilar weights for the set of target samples.

In one or more embodiments, an adversarial loss includes a loss determined for a computer-implemented neural network based on opposing values generated by the neural network. In particular, in some embodiments, an adversarial loss includes a loss that is based on a difference of output generated by components of a neural network based on opposing values generated using those components. For instance, in some implementations, an adversarial loss includes a loss that is based on source-similar weights and source-dissimilar weights generated using a source-classification neural network and a target classification neural network, respectively.

For example, in one or more embodiments, the classification domain adaptation system 106 optimizes the target classification neural network 306 (and, as will be explained below, the embedding model 308), using the following formulation:

$${min}_{F , {C}_{t}} - {\sum }_{i = 1}^{{n}_{t}} ( {α}_{i}^{s} > {α}_{i}^{t} ) σ ( {p}_{i}^{s} ) log ( σ ( {p}_{i}^{s} ) ) - {\sum }_{i = 1}^{{n}_{t}} ( {α}_{i}^{s} \leq {α}_{i}^{t} ) σ ( {p}_{i}^{t} ) log ( σ ( {p}_{i}^{t} ) ) \qquad ( 6 )$$

In equation 6, [symbol] (⋅) represents the indicator function. In one or more embodiments, the classification domain adaptation system 106 utilizes a different representation of equation 6. In particular, the classification domain adaptation system 106 utilizes a variation of equation 6 to accommodate cases to balance the trade-off between accepting novel knowledge about the target domain and preserving previously-learned knowledge about the source domain. Accordingly, in one or more embodiments, the classification domain adaptation system 106 utilizes the formulation of equation 6 to determine a first adversarial loss as follows:

$${ℒ}_{c} = - {\sum }_{i = 1}^{{n}_{t}} ( {α}_{i}^{s} σ ( {p}_{i}^{s} ) log ( σ ( {p}_{i}^{s} ) ) + {α}_{i}^{t} σ ( {p}_{i}^{t} ) log ( σ ( {p}_{i}^{t} ) ) ) \qquad ( 7 )$$

In one or more embodiments, the classification domain adaptation system 106 freezes αᵢ^{s} and αᵢ^{t} during operation. In some embodiments, the classification domain adaptation system 106 further determines a second and a third adversarial loss using the source-similar weights and the source-dissimilar weights for the set of target samples. For instance, in some cases, the classification domain adaptation system 106 determines the second and third adversarial losses to consider the source-similar and source-dissimilar high-level features distribution in the source and target domains, to reduce their discrepancies via alignment, and learn more discriminative features. In one or more embodiments, the classification domain adaptation system 106 determines the second and third adversarial losses via formal objective functions as follows:

$${min}_{{C}_{t}} {ℒ}_{{c}^{′}} = - {\sum }_{i = 1}^{{n}_{t}} ( {α}_{i}^{s} log ( {\sum }_{k = 1}^{K} {p}_{( i ) k}^{s t} ) + {α}_{i}^{t} log ( {\sum }_{k = K + 1}^{2 K} {p}_{( i ) k}^{s t} ) ) \qquad ( 8 )$$

$${min}_{F} {ℒ}_{{c}^{″}} = - {\sum }_{i = 1}^{{n}_{t}} ( {α}_{i}^{t} log ( {\sum }_{k = 1}^{K} {p}_{( i ) k}^{s t} ) + {α}_{i}^{s} log ( {\sum }_{k = K + 1}^{2 K} {p}_{( i ) k}^{s t} ) ) \qquad ( 9 )$$

As indicated by the above discussion αᵢ^{s} and αᵢ^{t} indicate, respectively, the probability that the target sample xᵢ^{t} is a source-similar target sample or a source-dissimilar target sample. Further, αᵢ^{s}+αᵢ^{t}=1. In the case when αᵢ^{s}≈1, the classification domain adaptation system 106 reduces the discriminability of the target classification neural network 306 for target sample xᵢ^{t}, via optimization of equation 8. By minimizing equation 9, the classification domain adaptation system 106 enables the embedding model 308 to engage in the inverse operation of mapping xᵢ^{t} into a high-level representation similar to source-dissimilar part.

In one or more embodiments, the classification domain adaptation system 106 modifies the parameters of the target classification neural network 306 using the first and the second adversarial losses (e.g., equations 7-8) as follows:

$${min}_{{C}_{t}} {ℒ}_{c} + {ℒ}_{{c}^{′}} \qquad ( 10 )$$

Thus, in one or more embodiments, the classification domain adaptation system 106 modifies the parameters of the target classification neural network 306 to align source-similar target samples and source-dissimilar target samples. In particular, in some embodiments, the classification domain adaptation system 106 modifies the parameters to reduce a distance between feature representations of source-similar target samples and feature representations of source-dissimilar target samples within a feature space corresponding to the target domain. Accordingly, in some embodiments, the classification domain adaptation system 106 reduces the difference between the source classification neural network 302 and the target classification neural network 306 in their analysis of target samples.

As further indicated by FIG. 3, the classification domain adaptation system 106 utilizes the source classification probabilities 314 generated using the source classification neural network 302 to modify the parameters of the embedding model 308 via contrastive category-wise matching. In particular, in one or more embodiments, the classification domain adaptation system 106 modifies the parameters of the embedding model 308 using a contrastive loss determined from the source classification probabilities 314 for the set of target samples.

In one or more embodiments, a contrastive loss includes a loss determined for a computer-implemented neural network based on pairs of target samples. In particular, in some embodiments, a contrastive loss includes a loss that is based on pairs of target samples having a degree of similarity. For instance, in some implementations, a contrastive loss includes a loss that is based on identified differences between a pair of target samples that are associated with the same class.

As will be explained more below, in some implementations, the classification domain adaptation system 106 further utilizes one or more adversarial losses determined using the source-similar weights and the source-dissimilar weights to modify the parameters of the embedding model 308.

As shown in FIG. 3, the classification domain adaptation system 106 determines similarities 324 between pairs of target samples from the set of target samples using the source classification probabilities 314 generated by the source classification neural network 302. In particular, for each pair of target samples, the classification domain adaptation system 106 generates a similarity metric using the source classification probabilities corresponding to those target samples. In one or more embodiments, a similarity metric includes a measure of a relationship between target samples. In particular, in some embodiments, a similarity metric includes a value that indicates the degree to which one target sample is similar or dissimilar to another target sample. In some cases, a similarity metric includes a degree of similarity between target samples that is based on an analysis of the target samples by a source classification neural network.

For instance, in one or more embodiments, the classification domain adaptation system 106 transforms each target sample into a label space by determining [symbol] ᵢ=σ(pᵢ^{s})∈ [symbol] ^{K}. Further, the classification domain adaptation system 106 generates a similarity metric for a pair of target samples including the target sample xᵢ^{t} and the target sample xⱼ^{t} as follows:

sᵢⱼ= [symbol] ᵢ^{T} [symbol] ⱼ (11)

According to equation 11, higher values of sᵢⱼ are stronger indications that the target sample xᵢ^{t} and the target sample xⱼ^{t} are associated with the same class (e.g., such as the circle class 330 or the triangle class 332 shown in FIG. 3). Example classes for digital images can include cars, animals, objects, or people. Example classes can also include a variety of other digital data categories (e.g., product classes, client device classes, consumer classes, user classes, etc.)

In one or more embodiments, based on the similarity metric, the classification domain adaptation system 106 determines whether the pair of target samples includes a positive sample pair. In one or more embodiments, a positive sample pair includes a pair of target samples that are associated with the same class. In particular, in some embodiments, a positive sample pair includes a pair of target samples having corresponding source classification probabilities that indicate that both target samples are likely associated with the same class. For instance, in some implementations, a positive sample pair includes a pairing of a first target sample and a second target sample with corresponding source classification probabilities, and the highest probability of each of the corresponding source classification probabilities is associated with the same class.

In some cases, the classification domain adaptation system 106 uses the similarity metric to determine whether the pair of target samples includes a positive sample pair, a negative sample pair, or there is uncertainty with regard to the pair of target samples as follows:

$$\{ \begin{matrix}μ ( t ) = {μ}_{0} - {λ}_{μ} \cdot t \\ ℓ ( t ) = {ℓ}_{0} + {λ}_{ℓ} \cdot t \\ 0 \leq ℓ ( t ) \leq μ ( t ) \leq 1\end{matrix} {γ}_{i j} = \{ \begin{matrix}1 , {s}_{i j} > μ ( t ) \\ - 1 , {s}_{i j} < ℓ ( t ) \\ 0 , otherwise\end{matrix} \qquad ( 12 )$$

In equation 12, μ(t) and [symbol] (t) represent the linear functions of epoch t starting from zero. Further, μ₀ and [symbol] ₀ are the initial upper and lower bounds, respectively. The classification domain adaptation system 106 utilizes λ_{μ} and [symbol] to separately control the decreasing and increasing rate of μ₀ and [symbol] ₀, respectively. Thus, as shown by equation 12, the classification domain adaptation system 106 determines that a pairing of target samples includes a positive sample pair (i.e., γᵢⱼ=1) when sᵢⱼ>μ(t) (e.g., the similarity metric satisfies a similarity upper bound) and determines that the pairing includes a negative sample pair (i.e., γᵢⱼ=−1) when sᵢⱼ< [symbol] (t) (e.g., the similarity metric is lower than a similarity lower bound). Additionally, the classification domain adaptation system 106 adaptively makes the determination for other pairings of target samples using the piecemeal change of μ(t) and [symbol] (t).

In one or more embodiments, the classification domain adaptation system 106 modifies the parameters of the embedding model 308 to achieve class-wise alignment among the target samples. In particular, the classification domain adaptation system 106 modifies the parameters of the embedding model 308 to emphasize the relationship between positive sample pairs. As mentioned, in some implementations, the classification domain adaptation system 106 modifies the parameters of the embedding model 308 using a contrastive loss. In some cases, the classification domain adaptation system 106 determines a contrastive loss for positive sample pairs that include a target sample xᵢ^{t} and a target sample xⱼ^{t} using the following:

$$ξ ( i , j ) = - log \frac{exp ( {s}_{i j} )}{{\sum }_{v = 1}^{b} ( v \neq i ) \vert {γ}_{i v} \vert exp ( {s}_{i v} )} \qquad ( 13 )$$

In equation 13, b represents the size of the set of target samples. In one or more embodiments, the classification domain adaptation system 106 determines that the optimization of equation 13 approximates the minimum value of function with sᵢⱼ→1 and that σ(pᵢ^{s}) and σ(pⱼ^{s}) follow the more similar probability distribution.

In one or more embodiments, the classification domain adaptation system 106 utilizes equation 13 to determine a contrastive loss as follows:

$${min}_{F} {ℒ}_{p} = [ μ ( λ ) > ℓ ( λ ) ] {\sum }_{i = 1}^{b} {\sum }_{j = 1 , j \neq i}^{b} ( {γ}_{i j} ) ξ ( i , j ) \qquad ( 14 )$$

Thus, as shown in equation 14, the classification domain adaptation system 106 determines the contrastive loss using the positive sample pairs but not the negative sample pairs nor the pairs of target samples having the uncertainty. Thus, the classification domain adaptation system 106 utilizes the contrastive loss so that target samples from the same class distribute closer to one another in the feature space. In other words, in one or more embodiments, the classification domain adaptation system 106 utilizes the contrastive loss to modify the parameters of the embedding model 308 to reduce a distance between feature representations of target samples corresponding to the same class within a feature space corresponding to the target domain. In some implementations, the classification domain adaptation system 106 determines the contrastive loss (or a separate contrastive loss) using negative sample pairs and/or those pairs of target samples for which there is uncertainty. For instance, in some cases, the classification domain adaptation system 106 utilizes a contrastive loss to increase the distance between target samples associated with different classes within the feature space corresponding to the target domain.

As mentioned, in one or more embodiments, the classification domain adaptation system 106 modifies the parameters of the embedding model 308 using the contrastive loss determined from the positive sample pairs (e.g., via back propagation as shown by the dashed line 326). As further, mentioned, in some embodiments, the classification domain adaptation system 106 modifies the parameters of the embedding model 308 utilizing one or more adversarial losses determined from the source-similar weight and source-dissimilar weights for the set of target samples (e.g., via back propagation as shown by the dashed line 328). For instance, in some cases, the classification domain adaptation system 106 modifies the parameters of the embedding model 308 utilizing the contrastive loss (equation 14), the first adversarial loss (equation 7), and the third adversarial loss (equation 9) as follows:

$${min}_{F} {ℒ}_{c} + {ℒ}_{{c}^{″}} + {ℒ}_{p} \qquad ( 15 )$$

Although equation 15 illustrates a particular set of losses for training the embedding model 308 and equation 10 illustrates a particular set of losses for training the target classification neural network 306, the classification domain adaptation system 106 can utilize different losses for training the different models. For example, the system can utilize each loss in these equations to train the embedding model 308 and/or the target classification neural network 306.

In one or more embodiments, the classification domain adaptation system 106 alternates between modifying the parameters of the target classification neural network 306 and modifying the parameters embedding model 308. Indeed, as previously discussed, in one or more embodiments, the classification domain adaptation system 106 utilizes the adaptive adversarial neural network 300 to generate the target classification neural network 306 via an iterative process. Thus, in some implementations, the classification domain adaptation system 106 modifies parameters of the embedding model 308 via a first set of parameter update iterations and modifies the parameters of the target classification neural network 306 via a second set of parameter update iterations. In one or more embodiments, the second set of parameter update iterations alternates periodically with the first set of parameter update iterations. For instance, in some cases, the classification domain adaptation system 106 modifies the parameters of the embedding model 308 via a first iteration, modifies the parameters of the target classification neural network 306 via a second iteration, modifies the parameters of the embedding model 308 again via a third iteration, and so forth until convergence has been reached. In some implementations, however, the classification domain adaptation system 106 modifies both the parameters of the target classification neural network 306 and the parameters of the embedding model 308 in each iteration.

Thus, the classification domain adaptation system 106 utilizes the adaptive adversarial neural network 300 to generate the target classification neural network 306 (e.g., generate the parameters that enable classification within the target domain). In one or more embodiments, the classification domain adaptation system 106 further implements the target classification neural network 306. In particular, the classification domain adaptation system 106 utilizes the target classification neural network 306 to analyze digital data from the target domain and generate classifications for the digital data based on the analysis as discussed with reference to FIG. 2.

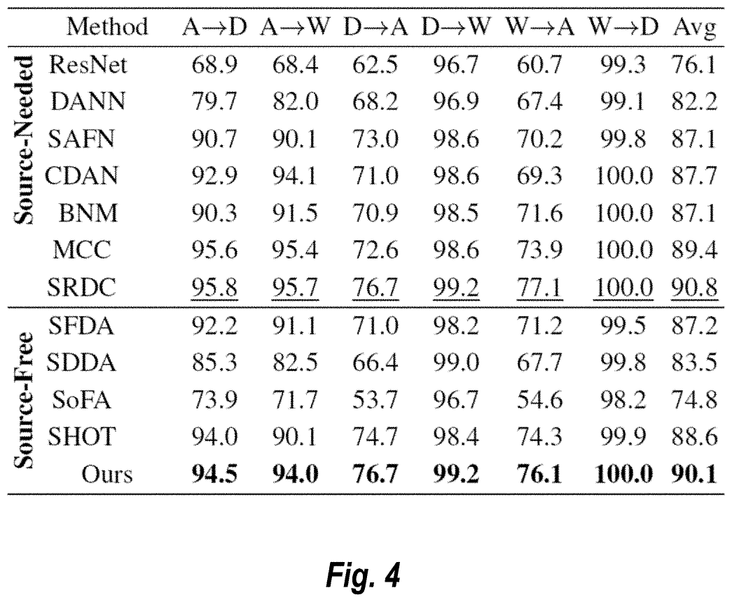

As mentioned above, in one or more embodiments, the classification domain adaptation system 106 operates more accurately than conventional systems. In particular, the classification domain adaptation system 106 utilizes domain adaptation to generate a target classification neural network that can more accurately generate classifications within the target domain. Researchers have conducted studies to determine the accuracy of one or more embodiments of the classification domain adaptation system 106. FIGS. 4-6 illustrate tables reflecting experimental results regarding the effectiveness of the classification domain adaptation system 106 in accordance with one or more embodiments.

As shown by the tables of FIGS. 4-6, the researchers compared the performance of an exemplary implementation of the classification domain adaptation system 106 (labeled “Ours”) with the performance of various baseline models, including models that utilize the source samples underlying the source classifier (referred to as “Source-Needed”). For instance, the tables show comparisons with the residual network model (labeled “ResNet”) described in Kaiming He et al., Deep Residual Learning for Image Recognition, Proceedings of the IEEE Conference on Computer Vision and Pattern Recognition, pages 770-778, 2016. Additionally, the tables show comparisons with the domain-adversarial neural network model (labeled “DANN”) described in Yaroslav Ganin et al., Domain-adversarial Training of Neural Networks, The Journal of Machine Learning Research, 17(1):2096-2030, 2016. Further, the tables include performance of the stepwise adaptive feature norm model (labeled “SAFN”) described in Ruijia Xu et al., Larger Norm More Transferable: An Adaptive Feature Norm Approach for Unsupervised Domain Adaptation, Proceedings of the IEEE/CVF International Conference on Computer Vision, pages 1426-1435, 2019. The tables also include performance of the conditional domain adversarial network model (labeled “CDAN”) described in Mingsheng Long et al., Conditional Adversarial Domain Adaptation, arXiv preprint arXiv: 1705.10667, 2017. Further, the tables show comparisons with the batch nuclear-norm maximization model (labeled “BNM”) described in Shuhao Cui et al., Towards Discriminability and Diversity: Batch Nuclear-norm Maximization Under Label Insufficient Situations, Proceedings of the IEEE/CVF Conference on Computer Vision and Pattern Recognition, pages 3941-3950, 2020. Additionally, the tables show performance of the minimum class confusion model (labeled “MCC”) described in Ying Jin et al., Minimum Class Confusion for Versatile Domain Adaptation, European Conference on Computer Vision, pages 464-480, Springer, 2020. Further, the tables show performance of the structurally regularized deep clustering model (labeled “SRDC”) described in Hui Tang et al., Unsupervised Domain Adaptation via Structurally Regularized Deep Clustering, Proceedings of the IEEE/CVF Conference on Computer Vision and Pattern Recognition, pages 8725-8735, 2020.

As further shown by the tables of FIGS. 4-6, the researchers compared the performance of the classification domain adaptation system 106 with models that perform domain adaptation without the underlying source samples (referred to as “Source-Free”). For instance, the tables include performance of the source data-free domain adaptation model (labeled “SFDA”) described in Youngeun Kim et al., Domain Adaptation without Source Data, arXiv preprint arXiv: 2007.01524, 2020. Further, the tables include performance of the source data free domain adaptation model (labeled “SDDA”) described in Vinod K Kurmi et al., Domain Impression: A Source Data Free Domain Adaptation Method, Proceedings of the IEEE/CVF Winter Conference on Applications of Computer Vision, pages 615-625, 2021. Additionally, the tables include performance of the source-data-free feature alignment model (labeled “SoFA”) described in Hao-Wei Yeh et al., SoFA: Source-data-free Feature Alignment for Unsupervised Domain Adaptation, Proceedings of the IEEE/CVF Winter Conference on Applications of Computer Vision, pages 474-483, 2021. The tables also include performance of the source hypothesis transfer model (labeled “SHOT”) described in Jian Liang et al., Do We Really Need to Access the Source Data? Source Hypothesis Transfer for Unsupervised Domain Adaptation, International Conference on Machine Learning, pages 6028-6039, PMLR, 2020.

The table of FIG. 4 provides the results of an object classification task on the Office-31 dataset described in Kate Saenko et al., Adapting Visual Category Models to New Domains, European Conference on Computer Vision, pages 213-226, Springer, 2010. This dataset includes an Amazon domain (labeled “A”) including 2,817 images, a Webcam domain (labeled “W”) including 795 images, and a DSLR domain (labeled “D”) that includes 498 images. The three domains share the label space with 31 different classes.

As shown by the table of FIG. 4, the classification domain adaptation system 106 outperforms each of the Source-Free models and provides comparable object classification accuracy to the top-performing Source-Needed models. Notably, the classification domain adaptation system 106 performs well when adapting from a relatively small source domain (e.g., the Webcam domain or the DSLR domain) to a relatively large domain (e.g., the Amazon domain).

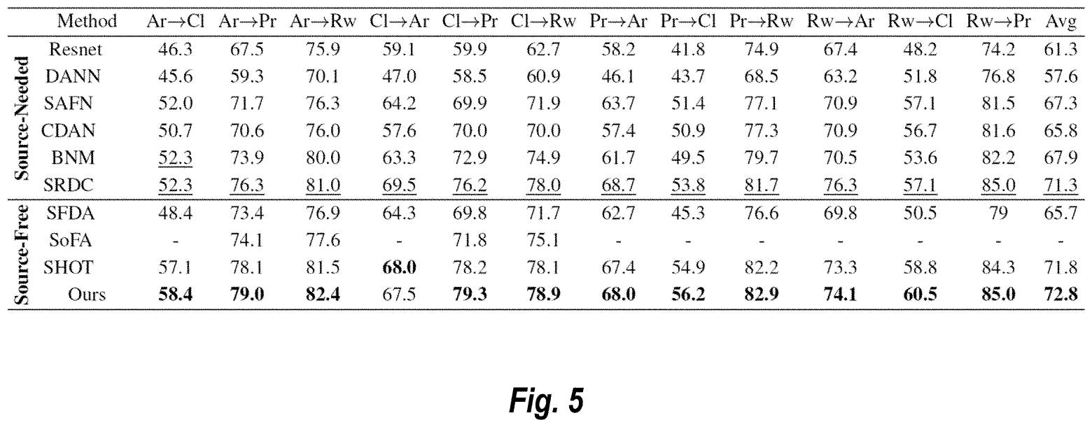

The table of FIG. 5 provides the results of an object classification task on the Office-Home dataset described in Hemanth Venkateswara et al., Deep Hashing Network for Unsupervised Domain Adaptation, Proceedings of the IEEE Conference on Computer Vision and Pattern Recognition, pages 5018-5027, 2017. This dataset includes 15,500 images collected from four domains: a Realworld domain (labeled “Rw”), a Clipart domain (labeled “Cl”), an Art domain (labeled “Ar”), and a Produce domain (labeled “Pr”). The dataset includes 65 classes per domain.

As shown by the table of FIG. 5, the classification domain adaptation system 106 provides the highest accuracy in most domain adaptation scenarios and further provides the highest average accuracy out of all tested models. Notably, there is a large increase in the number of classes represented by the Office-Home dataset when compared to the Office-31 dataset. While all tested models suffered performance degradation with this increase, the classification domain adaptation system 106 still outperformed the other models.

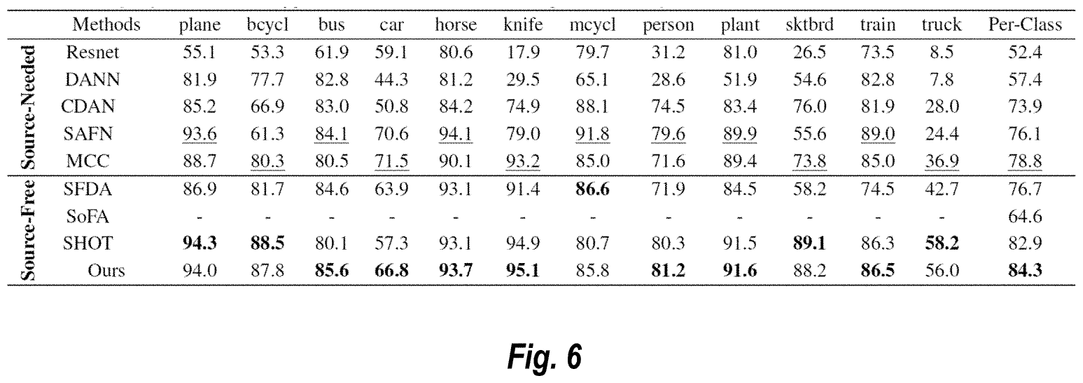

The table of FIG. 6 provides the results of an object classification task on the VisDA dataset described in Xingchao Peng et al., Visda: A Synthetic-to-real Benchmark for Visual Domain Adaptation, Proceedings of the IEEE Conference on Computer Vision and Pattern Recognition Workshops, pages 2021-2026, 2018. The VisDA dataset includes 12 classes used to evaluate model adaptation from a synthetic domain to a real domain. The source domain includes 152 thousand synthetic images which the 3D rendering model produces under various conditions. The dataset includes a validation set of 55 thousand real object images that correspond to the target domain. As shown by the table of FIG. 6, the classification domain adaptation system 106 provides the best overall (“Per-Class”) accuracy.

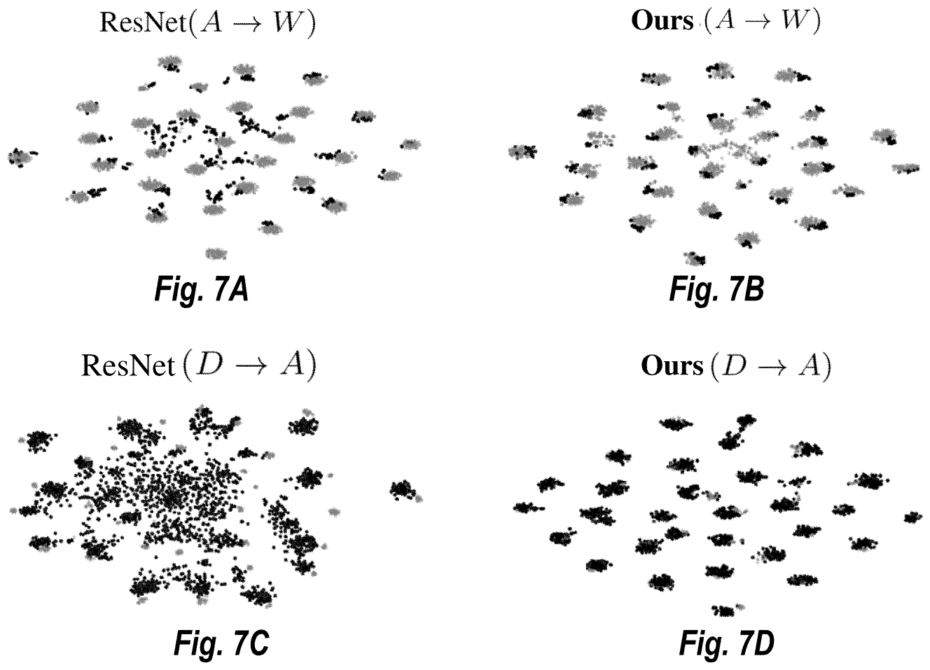

FIGS. 7A-7D illustrate graphical representations reflecting additional experimental results regarding the effectiveness of the classification domain adaptation system 106 in accordance with one or more embodiments. In particular, FIGS. 7A-7D illustrate visualizations of feature representations of digital data generated by the classification domain adaptation system 106 compared to those generated by the ResNet model on the Office-31 dataset. In FIGS. 7A-7D, the light-colored data representations correspond to the source domain and the dark-colored data representations correspond to the target domain.

As shown by FIGS. 7A-7B, both models exhibit effective generalization when adapting from a relatively large-scale source domain (e.g., the Amazon domain). As shown by FIG. 7C, however, when the ResNet model is learned on a relatively small-scale source domain (e.g., the DSLR domain), it generates feature representations from the target domain that are positioned far from the corresponding feature representations from the source domain within the feature space. Accordingly, the ResNet model experiences difficulty generating accurate classifications for the digital data from the target domain. As shown by FIG. 7D, the classification domain adaptation system 106 flexibly adapts to the data features from the target domain and generates feature representations from the target domain that are positioned close to the corresponding feature representations from the source domain within the feature space.

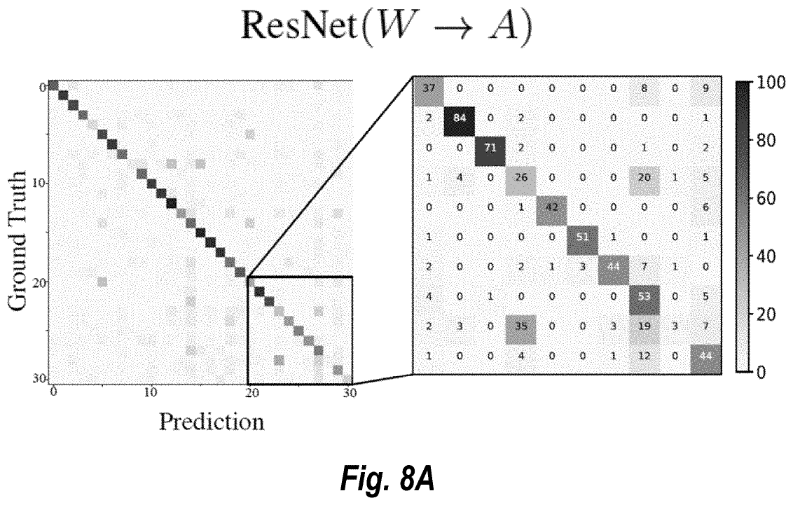

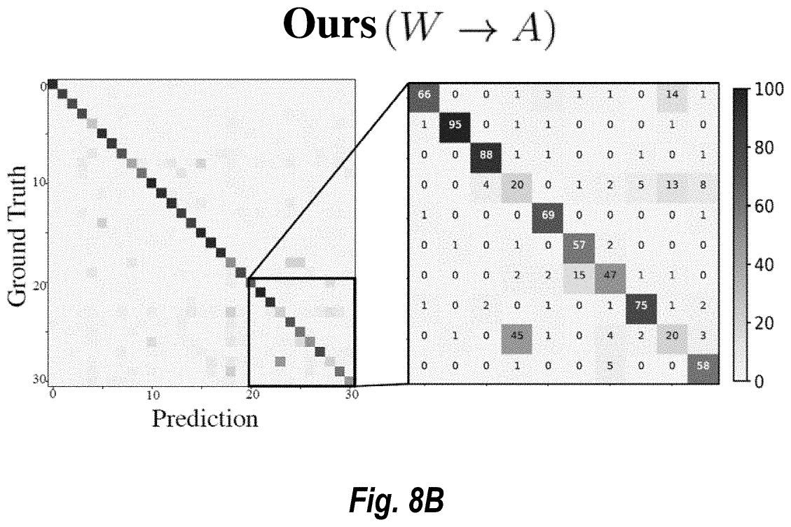

FIGS. 8A-8B illustrate graphical representations reflecting additional experimental results regarding the effectiveness of the classification domain adaptation system 106 in accordance with one or more embodiments. In particular, FIGS. 8A-8B illustrate confusion matrices corresponding to the ResNet model and the classification domain adaptation system 106, respectively. As shown by comparing the matrices of FIGS. 8A-8B, the classification domain adaptation system 106 learns a more compact category subspace by intensifying the association of positive sample pairs with contrastive loss to achieve category-wise matching across source-similar and source-dissimilar sets of digital data.

Turning now to FIG. 9, additional detail will now be provided regarding various components and capabilities of the classification domain adaptation system 106. In particular, FIG. 9 illustrates the classification domain adaptation system 106 implemented by the computing device 900 (e.g., the server(s) 102 and/or one of the client devices 110a-110n discussed above with reference to FIG. 1). Additionally, the classification domain adaptation system 106 is also part of the machine learning system 104. As shown, in one or more embodiments, the classification domain adaptation system 106 includes, but is not limited to, a target classification neural network generator 902, a target classification neural network application manager 904, and data storage 906 (which includes a target classification neural network 908, a source classification neural network 910, an embedding model 912, and target samples 914).

As just mentioned, and as illustrated in FIG. 9, the classification domain adaptation system 106 includes the target classification neural network generator 902. In one or more embodiments, the target classification neural network generator 902 generates a target classification neural network for classifying digital data from a target domain. For instance, in some cases, the target classification neural network generator 902 implements an adaptive adversarial neural network that includes a target classification neural network and a source classification neural network. Further, the target classification neural network generator 902 provides target samples to the adaptive adversarial neural network and modifies parameters of the target classification neural network based on the analysis of the target samples. In some cases, the target classification neural network generator 902 further modifies parameters of the embedding model included in the adaptive adversarial neural network based on the analysis of the target samples.

Additionally, as shown in FIG. 9, the classification domain adaptation system 106 includes the target classification neural network application manager 904. In one or more embodiments, the target classification neural network application manager 904 implements the target classification neural network generated by the target classification neural network generator 902. In particular, the target classification neural network application manager 904 utilizes the target classification neural network to generate classifications for digital data from the target domain. In some cases, the target classification neural network application manager 904 further utilizes the embedding model modified by the target classification neural network generator 902 to extract feature vectors for the digital data from the target domain.

Further, as shown in FIG. 9, the classification domain adaptation system 106 includes data storage 906. In particular, data storage 906 (implemented by one or more memory devices) includes the target classification neural network 908, the source classification neural network 910, the embedding model 912, and target samples 914. In one or more embodiments, target classification neural network 908 stores the target classification neural network generated by the target classification neural network generator 902 and implemented by the target classification neural network application manager 904. In some instances, source classification neural network 910 stores the source classification neural network utilized by the target classification neural network generator 902 to generate the target classification neural network. In some embodiments, the embedding model 912 stores the embedding model modified by the target classification neural network generator 902 and implemented by the target classification neural network application manager 904. In some implementations, target samples 914 stores the target samples utilized by the target classification neural network generator 902 to generate the target classification neural network.

Each of the components 902-914 of the classification domain adaptation system 106 can include software, hardware, or both. For example, the components 902-914 can include one or more instructions stored on a computer-readable storage medium and executable by processors of one or more computing devices, such as a client device or server device. When executed by the one or more processors, the computer-executable instructions of the classification domain adaptation system 106 can cause the computing device(s) to perform the methods described herein. Alternatively, the components 902-914 can include hardware, such as a special-purpose processing device to perform a certain function or group of functions. Alternatively, the components 902-914 of the classification domain adaptation system 106 can include a combination of computer-executable instructions and hardware.

Furthermore, the components 902-914 of the classification domain adaptation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 902-914 of the classification domain adaptation system 106 may be implemented as a stand-alone application, such as a desktop or mobile application. Furthermore, the components 902-914 of the classification domain adaptation system 106 may be implemented as one or more web-based applications hosted on a remote server. Alternatively, or additionally, the components 902-914 of the classification domain adaptation system 106 may be implemented in a suite of mobile device applications or “apps.” For example, in one or more embodiments, the classification domain adaptation system 106 can comprise or operate in connection with digital software applications such as ADOBE® CREATIVE CLOUD® or ADOBE® MARKETING CLOUD®. The foregoing are either registered trademarks or trademarks of Adobe Inc. in the United States and/or other countries.

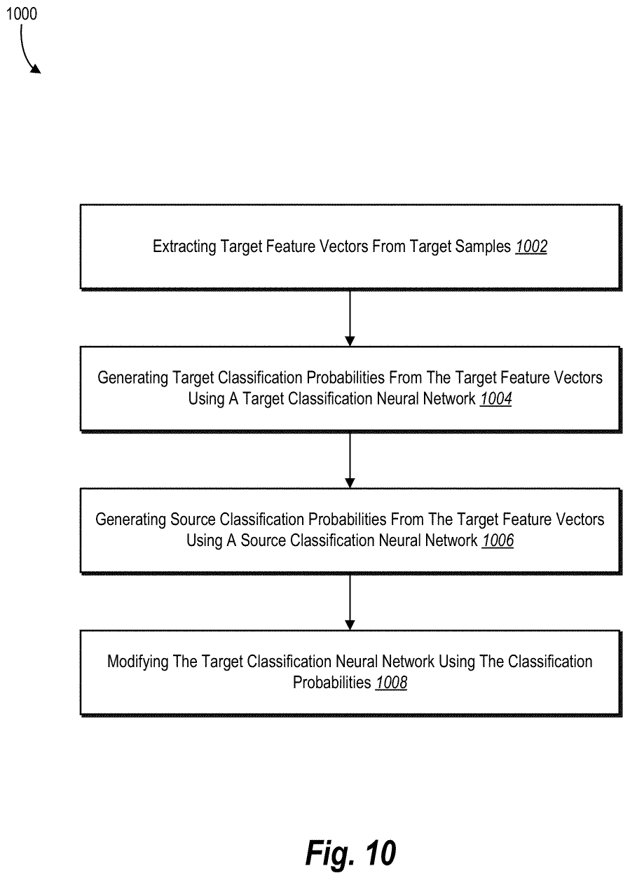

FIGS. 1-9, the corresponding text and the examples provide a number of different methods, systems, devices, and non-transitory computer-readable media of the classification domain adaptation system 106. In addition to the foregoing, one or more embodiments can also be described in terms of flowcharts comprising acts for accomplishing particular results, as shown in FIG. 10. FIG. 10 may be performed with more or fewer acts. Further, the acts may be performed in different orders. Additionally, the acts described herein may be repeated or performed in parallel with one another or in parallel with different instances of the same or similar acts.

FIG. 10 illustrates a flowchart of a series of acts 1000 for generating a target classification neural network for a target domain via domain adaptation of a source classification neural network learned on a source domain in accordance with one or more embodiments. While FIG. 10 illustrates acts according to one embodiment, alternative embodiments may omit, add to, reorder, and/or modify any of the acts shown in FIG. 10. In some implementations, the acts of FIG. 10 are performed as part of a method. For example, in some embodiments, the acts are performed as part of a computer-implemented method. In some instances, a non-transitory computer-readable medium stores instructions thereon that, when executed by at least one processor, cause a computing device to perform the acts of FIG. 10. In some implementations, a system performs the acts of FIG. 10. For example, in one or more cases, a system includes one or more memory devices comprising target samples from a target domain and an adaptive adversarial neural network comprising a target classification neural network for the target domain, a source classification neural network learned on a source domain, and an embedding model. The system further includes one or more server devices configured to cause the system to perform the acts of FIG. 10.

The series of acts 1000 includes an act 1002 for extracting target feature vectors from target samples. For example, in some embodiments, the act 1002 involves generating a target classification neural network for a target domain via domain adaptation of a source classification neural network learned on a source domain by extracting target feature vectors from a set of target samples from the target domain.

The series of acts 1000 also includes an act 1004 for generating target classification probabilities from the target feature vectors using a target classification neural network. For instance, in some implementations, the act 1004 involves generating a target classification neural network for a target domain via domain adaptation of a source classification neural network learned on a source domain by further generating, utilizing the target classification neural network, target classification probabilities for the set of target samples from the target feature vectors. In one or more embodiments, generating, utilizing the target classification neural network, the target classification probabilities comprises generating distributions of probabilities across a plurality of classes using the target classification neural network.

The series of acts 1000 further includes an act 1006 for generating source classification probabilities from the target feature vectors using a source classification neural network. For example, in one or more embodiments, the act 1006 involves generating a target classification neural network for a target domain via domain adaptation of a source classification neural network learned on a source domain by further generating, utilizing the source classification neural network, source classification probabilities for the set of target samples from the target feature vectors. In some implementations, generating, utilizing the source classification neural network, the source classification probabilities comprises generating (e.g., additional) distributions of probabilities across the plurality of classes using the source classification neural network.

Further, the series of acts 1000 includes an act 1008 for modifying the target classification neural network using the classification probabilities. For instance, in some cases, the act 1008 involves generating a target classification neural network for a target domain via domain adaptation of a source classification neural network learned on a source domain by further modifying parameters of the target classification neural network utilizing the target classification probabilities and the source classification probabilities.

In one or more embodiments, modifying the parameters of the target classification neural network comprises modifying the parameters of the target classification neural network to reduce a distance between feature representations of source-similar target samples and feature representations of source-dissimilar target samples within a feature space corresponding to the target domain.

In some implementations, the classification domain adaptation system 106 determines, for a target sample from the set of target samples, a source-similar weight and a source-dissimilar weight from a corresponding target classification probability and a corresponding source classification probability. Accordingly, in some cases, the classification domain adaptation system 106 modifies the parameters of the target classification neural network using the source-similar weight and the source-dissimilar weight for the target sample.

In some embodiments, the series of acts 1000 further includes acts for modifying parameters of an embedding model learned on the source domain. For instance, in some cases, the acts include extracting, utilizing an embedding model learned on the source domain, additional target feature vectors from an additional set of target samples from the target domain; generating, utilizing the target classification neural network, additional target classification probabilities for the additional set of target samples from the additional target feature vectors; generating, utilizing the source classification neural network, additional source classification probabilities for the additional set of target samples from the additional target feature vectors; and modifying parameters of the embedding model using the additional target classification probabilities and the additional source classification probabilities. In some embodiments, extracting the target feature vectors from the set of target samples from the target domain comprises extracting the target feature vectors from the set of target samples utilizing the embedding model with the modified parameters.

In one or more embodiments, the classification domain adaptation system 106 further determines positive sample pairs from the additional set of target samples using the additional source classification probabilities. Accordingly, in some cases, modifying the parameters of the embedding model comprises modifying the parameters using a contrastive loss based on the positive sample pairs, the additional target classification probabilities, and the additional source classification probabilities. In one or more embodiments, determining the positive sample pairs from the additional set of target samples using the additional source classification probabilities comprises, for a first target sample and a second target sample from the additional set of target samples: generating a similarity metric for the first target sample and the second target sample using corresponding additional source classification probabilities; and determining that a pairing of the first target sample and the second target sample corresponds to a positive sample pair based on the similarity metric. In one or more embodiments, determining that the pairing of the first target sample and the second target sample corresponds to the positive sample pair based on the similarity metric comprises comparing the similarity metric to a similarity upper bound.

To provide an illustration, in one or more embodiments, the classification domain adaptation system 106 generates a target classification neural network for a target domain via domain adaptation of a source classification neural network learned on a source domain by: extracting, utilizing an embedding model learned on the source domain, target feature vectors from target samples from the target domain; generating, utilizing the target classification neural network, target classification probabilities using the target feature vectors; generating, utilizing the source classification neural network, source classification probabilities using the target feature vectors; determining positive sample pairs using the source classification probabilities; and modifying parameters of the embedding model and parameters of the target classification neural network using the positive sample pairs, the target classification probabilities, and the source classification probabilities.

In some cases, the classification domain adaptation system 106 determines the positive sample pairs using the source classification probabilities by: determining a similarity metric that measures a relationship between a first target sample and a second target sample using source classification probabilities that correspond to the first target sample and the second target sample; and determining that the first target sample and the second target sample correspond to a positive sample pair by comparing the similarity metric to a similarity upper bound.

In some implementations, the classification domain adaptation system 106 modifies the parameters of the target classification neural network using the target classification probabilities and the source classification probabilities by: determining a first adversarial loss and a second adversarial loss using the target classification probabilities and the source classification probabilities; and modifying the parameters of the target classification neural network using the first adversarial loss and the second adversarial loss. In some cases, the classification domain adaptation system 106 modifies the parameters of the embedding model using the positive sample pairs, the target classification probabilities, and the source classification probabilities by: determining a third adversarial loss using the target classification probabilities and the source classification probabilities; determining a contrastive loss based on the positive sample pairs; and modifying the parameters of the embedding model using the first adversarial loss, the third adversarial loss, and the contrastive loss. In one or more embodiments, the classification domain adaptation system 106 modifies the parameters of the embedding model to reduce a distance between feature representations of target samples corresponding to a same class within a feature space corresponding to the target domain.

In one or more embodiments, the classification domain adaptation system 106 modifies the parameters of the embedding model via a first set of parameter update iterations; and modifies the parameters of the target classification neural network via a second set of parameter update iterations that alternates periodically with the first set of parameter update iterations. Accordingly, in some cases, the classification domain adaptation system 106 extracts the target feature vectors from the target samples from the target domain by extracting a set of target feature vectors from a set of target samples for the second set of parameter update iterations utilizing the embedding model with modified parameters.

To provide another illustration, in some implementations, the classification domain adaptation system 106 extracts, utilizing the embedding model, target feature vectors from a set of target samples of the target samples; generates, utilizing the target classification neural network, target classification probabilities for the set of target samples from the target feature vectors; generates, utilizing the source classification neural network, source classification probabilities for the set of target samples from the target feature vectors; determines source-similar weights and source-dissimilar weights for the set of target samples using combinations of the target classification probabilities and the source classification probabilities; and modifies parameters of the target classification neural network using the source-similar weights and source-dissimilar weights.

In some cases, the classification domain adaptation system 106 modifies the parameters of the target classification neural network using the source-similar weights and source-dissimilar weights by: determining a first adversarial loss and a second adversarial loss using the source-similar weights and source-dissimilar weights; and modifying the parameters of the target classification neural network using the first adversarial loss and the second adversarial loss. In some implementations, the classification domain adaptation system 106 further extracts, utilizing the embedding model, additional target feature vectors from an additional set of target samples from the target domain; and modifies parameters of the embedding model using the additional target feature vectors. For instance, in some cases, the classification domain adaptation system 106 modifies the parameters of the embedding model using the additional target feature vectors by: determining positive sample pairs from the additional set of target samples using the additional target feature vectors; and modifying the parameters of the embedding model using a contrastive loss based on the positive sample pairs.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., the server(s) 102 and/or the client devices 110a-110n). In one or more embodiments, the computing device 1100 may be a mobile device (e.g., a mobile telephone, a smartphone, a PDA, a tablet, a laptop, a camera, a tracker, a watch, a wearable device). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising generating a target classification neural network for a target domain via domain adaptation of a source classification neural network learned on a source domain by:
extracting target feature vectors from a set of target samples from the target domain;
generating, utilizing the target classification neural network, target classification probabilities for the set of target samples from the target feature vectors;
generating, utilizing the source classification neural network, source classification probabilities for the set of target samples from the target feature vectors; and
modifying parameters of the target classification neural network utilizing the target classification probabilities and the source classification probabilities.

2. The computer-implemented method of claim 1, further comprising:
determining, for a target sample from the set of target samples, a source-similar weight and a source-dissimilar weight from a corresponding target classification probability and a corresponding source classification probability; and
modifying the parameters of the target classification neural network using the source-similar weight and the source-dissimilar weight for the target sample.

3. The computer-implemented method of claim 1, wherein modifying the parameters of the target classification neural network comprises modifying the parameters of the target classification neural network to reduce a distance between feature representations of source-similar target samples and feature representations of source-dissimilar target samples within a feature space corresponding to the target domain.

4. The computer-implemented method of claim 1, further comprising:
extracting, utilizing an embedding model learned on the source domain, additional target feature vectors from an additional set of target samples from the target domain;
generating, utilizing the target classification neural network, additional target classification probabilities for the additional set of target samples from the additional target feature vectors;
generating, utilizing the source classification neural network, additional source classification probabilities for the additional set of target samples from the additional target feature vectors; and
modifying parameters of the embedding model using the additional target classification probabilities and the additional source classification probabilities.

5. The computer-implemented method of claim 4, wherein extracting the target feature vectors from the set of target samples from the target domain comprises extracting the target feature vectors from the set of target samples utilizing the embedding model with the modified parameters.

6. The computer-implemented method of claim 4,
further comprising determining positive sample pairs from the additional set of target samples using the additional source classification probabilities,
wherein modifying the parameters of the embedding model comprises modifying the parameters using a contrastive loss based on the positive sample pairs, the additional target classification probabilities, and the additional source classification probabilities.

7. The computer-implemented method of claim 6, wherein determining the positive sample pairs from the additional set of target samples using the additional source classification probabilities comprises, for a first target sample and a second target sample from the additional set of target samples:
generating a similarity metric for the first target sample and the second target sample using corresponding additional source classification probabilities; and
determining that a pairing of the first target sample and the second target sample corresponds to a positive sample pair based on the similarity metric.

8. The computer-implemented method of claim 7, wherein determining that the pairing of the first target sample and the second target sample corresponds to the positive sample pair based on the similarity metric comprises comparing the similarity metric to a similarity upper bound.

9. The computer-implemented method of claim 1, wherein:
generating, utilizing the target classification neural network, the target classification probabilities comprises generating distributions of probabilities across a plurality of classes using the target classification neural network; and
generating, utilizing the source classification neural network, the source classification probabilities comprises generating additional distributions of probabilities across the plurality of classes using the source classification neural network.

10. A non-transitory computer-readable medium storing instructions thereon that, when executed by at least one processor, cause a computing device to generate a target classification neural network for a target domain via domain adaptation of a source classification neural network learned on a source domain by:
extracting, utilizing an embedding model learned on the source domain, target feature vectors from target samples from the target domain;
generating, utilizing the target classification neural network, target classification probabilities using the target feature vectors;
generating, utilizing the source classification neural network, source classification probabilities using the target feature vectors;
determining positive sample pairs using the source classification probabilities; and
modifying parameters of the embedding model and parameters of the target classification neural network using the positive sample pairs, the target classification probabilities, and the source classification probabilities.

11. The non-transitory computer-readable medium of claim 10, further comprising instructions that, when executed by the at least one processor, cause the computing device to modify the parameters of the embedding model to reduce a distance between feature representations of target samples corresponding to a same class within a feature space corresponding to the target domain.

12. The non-transitory computer-readable medium of claim 10, further comprising instructions that, when executed by the at least one processor, cause the computing device to modify the parameters of the target classification neural network using the target classification probabilities and the source classification probabilities by:
determining a first adversarial loss and a second adversarial loss using the target classification probabilities and the source classification probabilities; and
modifying the parameters of the target classification neural network using the first adversarial loss and the second adversarial loss.

13. The non-transitory computer-readable medium of claim 12, further comprising instructions that, when executed by the at least one processor, cause the computing device to modify the parameters of the embedding model using the positive sample pairs, the target classification probabilities, and the source classification probabilities by:
determining a third adversarial loss using the target classification probabilities and the source classification probabilities;
determining a contrastive loss based on the positive sample pairs; and
modifying the parameters of the embedding model using the first adversarial loss, the third adversarial loss, and the contrastive loss.

14. The non-transitory computer-readable medium of claim 10, further comprising instructions that, when executed by the at least one processor, cause the computing device to determine the positive sample pairs using the source classification probabilities by:
determining a similarity metric that measures a relationship between a first target sample and a second target sample using source classification probabilities that correspond to the first target sample and the second target sample; and
determining that the first target sample and the second target sample correspond to a positive sample pair by comparing the similarity metric to a similarity upper bound.

15. The non-transitory computer-readable medium of claim 10, further comprising instructions that, when executed by the at least one processor, cause the computing device to:
modify the parameters of the embedding model via a first set of parameter update iterations; and
modify the parameters of the target classification neural network via a second set of parameter update iterations that alternates periodically with the first set of parameter update iterations.

16. The non-transitory computer-readable medium of claim 15, further comprising instructions that, when executed by the at least one processor, cause the computing device to extract the target feature vectors from the target samples from the target domain by extracting a set of target feature vectors from a set of target samples for the second set of parameter update iterations utilizing the embedding model with modified parameters.

17. A system comprising:
one or more memory devices comprising:
target samples from a target domain; and
an adaptive adversarial neural network comprising a target classification neural network for the target domain, a source classification neural network learned on a source domain, and an embedding model; and
one or more server devices configured to cause the system to:
extract, utilizing the embedding model, target feature vectors from a set of target samples of the target samples;
generate, utilizing the target classification neural network, target classification probabilities for the set of target samples from the target feature vectors;
generate, utilizing the source classification neural network, source classification probabilities for the set of target samples from the target feature vectors;
determine source-similar weights and source-dissimilar weights for the set of target samples using combinations of the target classification probabilities and the source classification probabilities; and
modify parameters of the target classification neural network using the source-similar weights and source-dissimilar weights.

18. The system of claim 17, wherein the one or more server devices are configured to cause the system to modify the parameters of the target classification neural network using the source-similar weights and source-dissimilar weights by:
determining a first adversarial loss and a second adversarial loss using the source-similar weights and source-dissimilar weights; and
modifying the parameters of the target classification neural network using the first adversarial loss and the second adversarial loss.

19. The system of claim 17, wherein the one or more server devices are further configured to cause the system to:
extract, utilizing the embedding model, additional target feature vectors from an additional set of target samples from the target domain; and
modify parameters of the embedding model using the additional target feature vectors.

20. The system of claim 19, wherein the one or more server devices are configured to cause the system to modify the parameters of the embedding model using the additional target feature vectors by:
determining positive sample pairs from the additional set of target samples using the additional target feature vectors; and
modifying the parameters of the embedding model using a contrastive loss based on the positive sample pairs.
